(19) United States
(12) Patent Application Publication
(10) Pub. No.: US 2005/0283825 A1
(43) Pub. Date: Dec. 22, 2005

(54) Method and system for providing networked physical security

(75) Inventors: Christopher Fox, San Antonio, TX (US); James Straus, Austin, TX (US)

Correspondence Address: DAVIS LAW GROUP, P.C., 9020 N. CAPITAL OF TEXAS HWY., BUILDING 1, SUITE 375, AUSTIN, TX, 78759, US

(73) Assignee: NovusEdge, Inc., Austin, TX (US)

(21) Appl. No.: 10/870,628

(22) Filed: Jun. 17, 2004

(51) Int. Cl. G06F 17/30

(52) U.S. Cl. 726/2

(57) ABSTRACT

An information handling system outputs via an Internet protocol, a message, in response to which, one or more devices perform one or more operations for providing physical security.

### CROSS-REFERENCE TO RELATED APPLICATIONS

This application relates to co-pending U.S. patent application Ser. No. ______, entitled METHOD AND SYSTEM FOR PROVIDING FAULT TOLERANT PHYSICAL SECURITY, which is filed concurrently herewith, names Christopher Fox and James Straus as inventors, is incorporated herein by reference in its entirety, and is assigned to the assignee of this application.

### BACKGROUND

This description relates in general to security systems and in particular to a method and system for providing physical security. A system for providing physical security (e.g., physical security of entry points and premises) may include various devices such as one or more sensors (e.g., sensors for detecting whether a door is ajar), actuators (e.g., an electronic door strike), and controllers for controlling the sensors and the actuators. Such a system may present various problems including problems associated with implementing and managing the devices, and failure of the devices.

### SUMMARY

An information handling system outputs via an Internet protocol, a message, in response to which, one or more devices perform one or more operations for providing physical security.

### BRIEF DESCRIPTION OF THE DRAWING

FIG. 1 is a block diagram of a physical security system according to the illustrative embodiment.

FIG. 2 is a block diagram of an information handling system (“IHS”) representative of the server and the client of FIG. 1.

FIG. 3 is a block diagram of an IHS representative of the controllers of FIG. 1.

FIG. 4 is a block diagram of an IHS representative of the interface modules of FIG. 1 according to a first embodiment.

FIG. 5 is a block diagram of an IHS representative of the interface modules of FIG. 1 according to a second embodiment.

FIG. 6 is a flow chart of operations of a first process executed by at least one of the controllers of FIG. 1.

FIG. 7 is an illustration of organization of an address translation database according to a first embodiment.

FIG. 8 is a flow chart of operations of a second process executed by at least one of the controllers of the FIG. 1.

FIG. 9 is an illustration of organization of a message output by the sensor or the actuator of FIG. 1, according to the illustrative embodiment.

FIG. 10 is an illustration of organization of an address translation database according to a second embodiment.

FIG. 11 is a flow chart of operations of a process executed by an interface module of FIG. 1.

FIG. 12 is a block diagram of an interconnection between one of the interface modules of FIG. 1, and one of the sensors and one of the actuators of FIG. 1.

FIG. 13 is an illustration of organization of a packet output and received by the devices that are coupled to the network 114 of FIG. 1, according to a first embodiment.

FIG. 14 is an illustration of organization of a packet output and received by the devices that are coupled to the network 114 of FIG. 1, according to a second embodiment.

### DETAILED DESCRIPTION

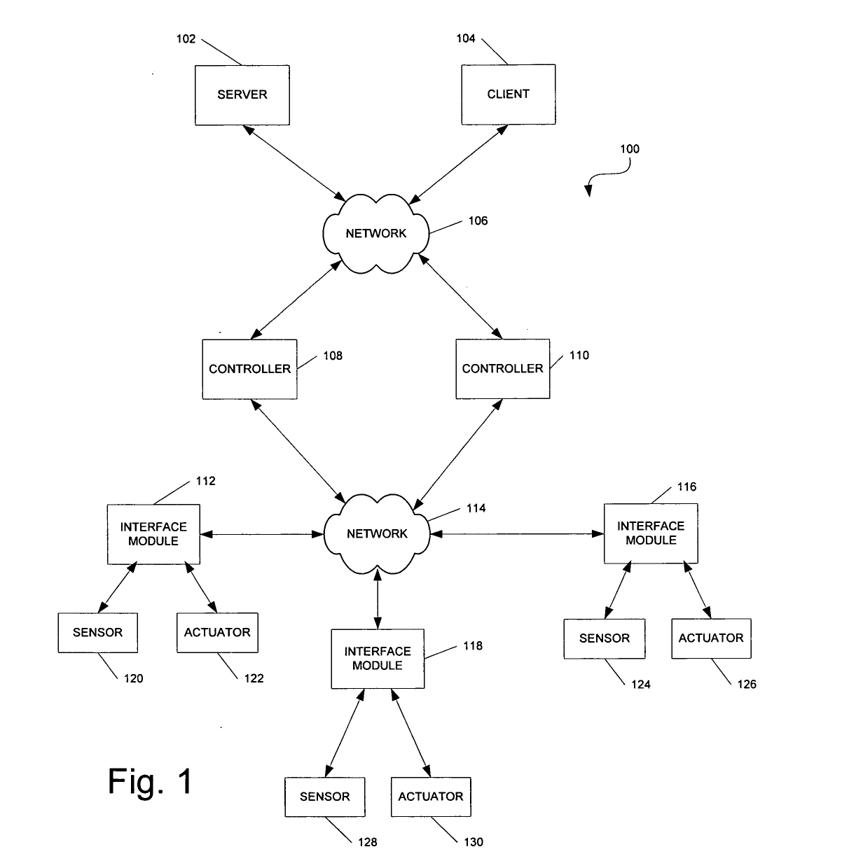

FIG. 1 is a block diagram of a security system for providing physical security (e.g., monitoring and/or controlling a variety of physical environmental conditions, such as temperature and chemical levels (e.g., in air or water)), indicated generally at 100 according to the illustrative embodiment. The system 100 includes a server 102, a client 104, controllers (e.g., controller devices) 108 and 110, and interface modules 112, 116, and 118. The system 100 also includes a network 106, which is a Transport Control Protocol/Internet Protocol (“TCP/IP”) network (e.g., the Internet or an intranet), and a network 114, which is a different type of network from the network 110. In the illustrative embodiment, the network 114 is a serial network (e.g., a RS485 network). However, in at least one alternative embodiment, the network 114 is a wireless network (e.g., a wireless mesh network).

Each of the server 102, the client 104 , and controllers 108 and 110 includes a respective network interface for communicating with the network 106 (e.g., outputting information to and, and receiving information from, the network 106), such as by transferring information (e.g., instructions, data, signals) between such servers, controllers, and the network 106. Accordingly, through the network 106, each of the server 102, the client 104, and controllers 108 and 110 communicates with each other. Also, each of the server 102, the client 104, and controllers 108 and 110 is a TCP/IP device.

Each of the interface modules 112, 116, and 118 includes a respective network interface for communicating with the network 114, such as by transferring information between such interface modules and the network 114. Also, each of the controllers 108 and 110 includes a respective network interface for communicating with the network 114. Accordingly, through the network 114, each of the interface modules 112, 116, and 118, and controllers 108 and 110 communicates with each other.

The system 100 includes a sensor 120, and an actuator 122, each of which is coupled to the interface module 112. Also, the system 100 includes a sensor 124 and an actuator 126, each of which is coupled to the interface module 116. Moreover, the system 100 includes a sensor 128 and an actuator 130, each of which is coupled to the interface module 118. In at least one alternative embodiment, such sensors and actuators are included by the respective interface module to which they are coupled.

For clarity, FIG. 1 depicts only one server 102 although the system 100 may include additional servers which are substantially identical to one another. Similarly for clarity, FIG. 1 depicts only one client 104 although the system 100 may include additional clients which are substantially identical to one another. Likewise, for clarity, FIG. 1 depicts only two controllers 108 and 110 although the system 100 may include additional controllers which are substantially identical to one another. Further, for clarity, FIG. 1 depicts only one sensor and one actuator coupled to each of the interface modules although the system 100 may include additional sensors and actuators. In the discussion below, the controller 108 is a representative one of the controllers 108 and 110, and interface module 112 is a representative one of the interface modules 112, 116, and 118.

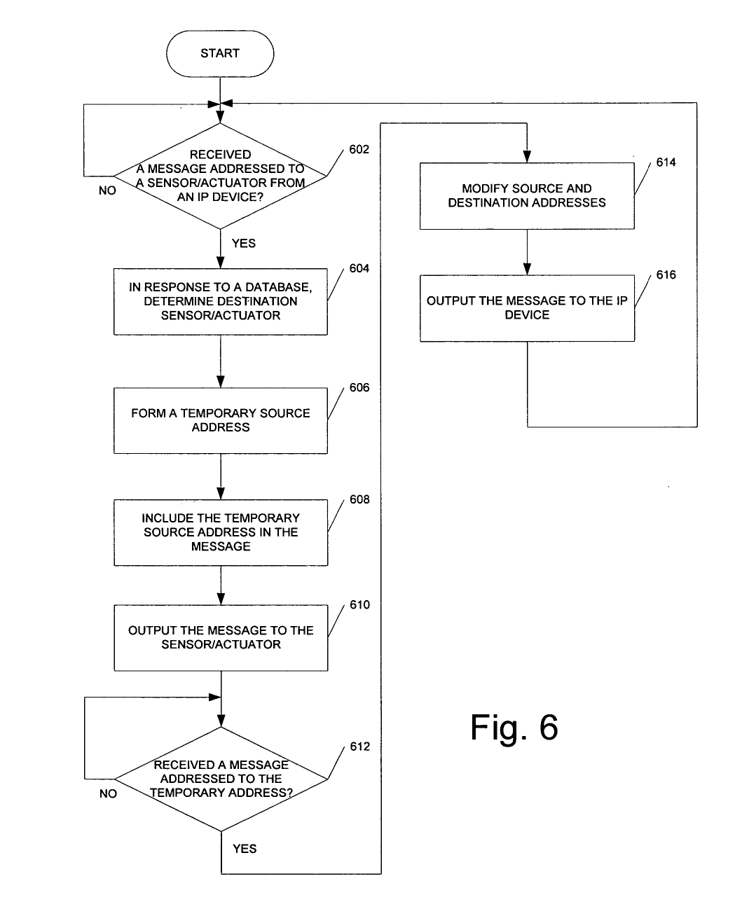

Each of the servers 102, the client 104, the controller 108, and the interface module 118 is a respective information handling system (“IHS”) for executing processes and performing operations (e.g., processing and communicating information) in response thereto, as discussed further below in connection with FIGS. 6-11. Each such IHS is formed by various electronic circuitry components. Moreover, as shown in FIG. 1, all such IHSs are coupled to one another. Accordingly, each of the server 102, the client 104, the controller 108, and the interface module 112 operates within the networks 106 and 114.

In at least one embodiment, each of the controller 108 and/or the interface module 118 is a mobile device. Also, in at least one embodiment, the client 104 is a handheld device (e.g., a personal digital assistant (“PDA”)).

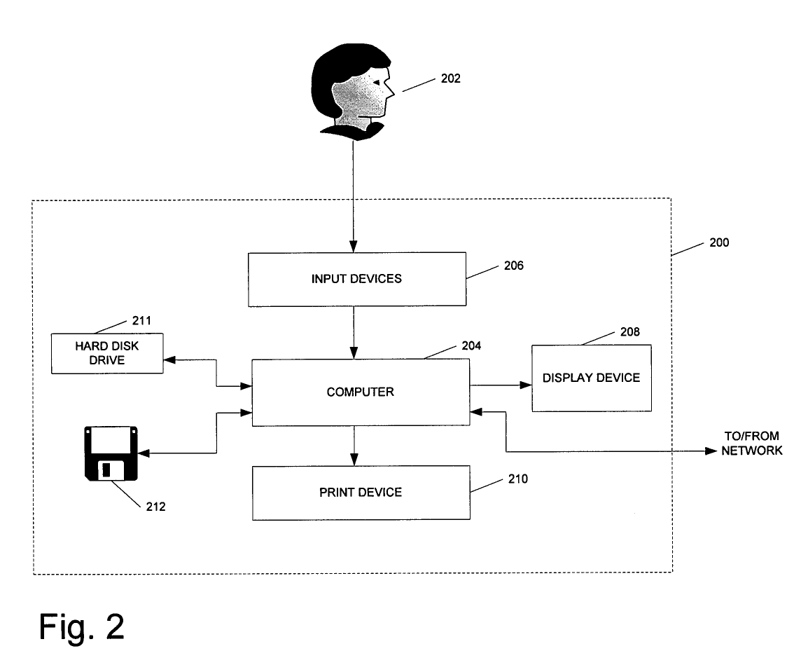

FIG. 2 is a block diagram of an IHS that is representative of the server 102 and the client 104 of FIG. 1. Such representative IHS is indicated by dashed enclosure 200. In the illustrative embodiment, each IHS of FIG. 1 is operable in association with a respective human user. Accordingly, in the example of FIG. 2, the IHS 200 is operable in association with a human user 202, as discussed further hereinbelow.

As shown in FIG. 2, the IHS 200 includes (a) a computer 204 for executing and otherwise processing instructions, (b) input devices 206 for receiving information from human user 202, (c) a display device 208 (e.g., a conventional electronic cathode ray tube (“CRT”) device) for displaying information to user 202, (d) a print device 210 (e.g., a conventional electronic printer or plotter) for printing visual images (e.g., textual and graphic information) on paper, (e) a nonvolatile storage device 211 (e.g., a hard disk drive or other computer-readable medium (or apparatus), as discussed further hereinbelow) for storing information, (f) a computer-readable medium (or apparatus) 212 (e.g., a portable floppy diskette) for storing information, and (g) various other electronic circuitry for performing other operations of the IHS 200.

For example, the computer 204 includes (a) a network interface (e.g., circuitry) for communicating between the computer 204 and the network (e.g., the network 106) and (b) a memory device (e.g., random access memory (“RAM”) device and read only memory (“ROM”) device) for storing information (e.g., instructions executed by computer 204 and data operated upon by computer 204 in response to such instructions). Accordingly, the computer 204 is connected to the network, the input devices 206, the display device 208, the print device 210, the storage device 211, and the computer-readable medium 212, as shown in FIG. 2.

For example, in response to signals from the computer 204, the display device 208 displays visual images, and the user 202 views such visual images. Moreover, the user 202 operates the input devices 206 in order to output information to the computer 204, and the computer 204 receives such information from the input devices 206. Also, in response to signals from the computer 204, the print device 210 prints visual images on paper, and the user 202 views such visual images.

The input devices 206 include, for example, a conventional electronic keyboard and a pointing device such as a conventional electronic “mouse”, rollerball or light pen. The user 202 operates the keyboard to output alphanumeric text information to the computer 204, and the computer 204 receives such alphanumeric text information from the keyboard. The user 202 operates the pointing device to output cursor-control information to the computer 204, and the computer 204 receives such cursor-control information from the pointing device.

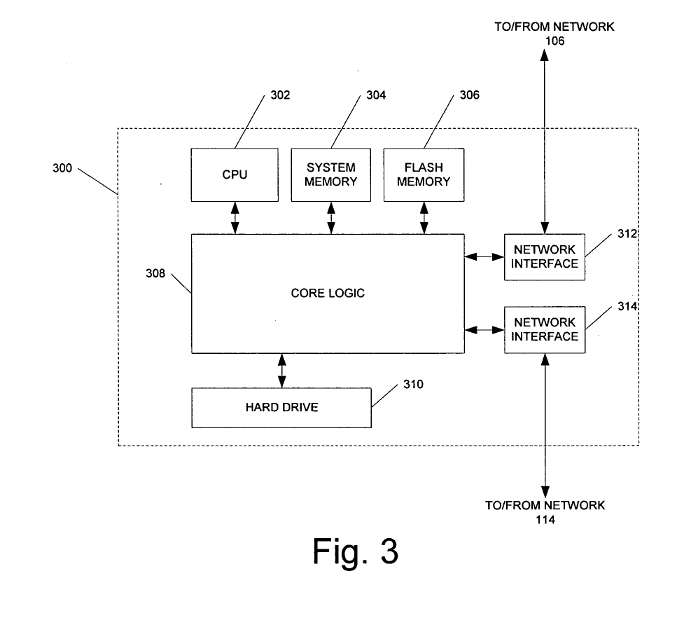

FIG. 3 is block diagram of an IHS that is representative of the controller 108, according to the illustrative embodiment. Such representative IHS is indicated by a dashed enclosure 300. The IHS 300 includes a central processing unit (“CPU”) 302 for executing and otherwise processing one or more instructions, a system memory (e.g., RAM and/or ROM) 304, a flash memory 306 (discussed in more detail hereinbelow), a optional hard disk drive 310, a network interface 312 (e.g., an Ethernet 10/100 megabyte interface) for communicating between the IHS 300 and the network 106, and a network interface 314 (e.g., an RS485 interface) for communicating between the controller 108 and the network 114.

The IHS 300 also includes a core logic 308, which includes electronic circuitry for communicating information and signals (e.g. interfacing or bridging) between the CPU 302 and other electronic circuitry and devices (e.g., the network interface 312). Accordingly, each of the CPU 302, the system memory 304, the flash memory 306, the hard disk drive 310, the network interface 312, and the network interface 314 is coupled to the core logic 308.

Although not shown for clarity, the IHS 300 includes various features discussed hereinbelow. For example, the IHS 300 includes a power system. Examples of the power system include power over Ethernet (“POE”)/Shore power, alternating current (“A/C”) power, and battery power. The IHS 300 also includes a battery powered real time clock, and a watchdog system. Moreover, the IHS 300 is capable of operating in association with Federal Information Processing Standards (“FIPS”). FIPS are a set of standards that describe document processing, provide standard algorithms for searching, and provide information processing standards for use within government agencies. In at least one embodiment, the IHS 300 includes a FIPS co-processor, which is included by the core logic 308.

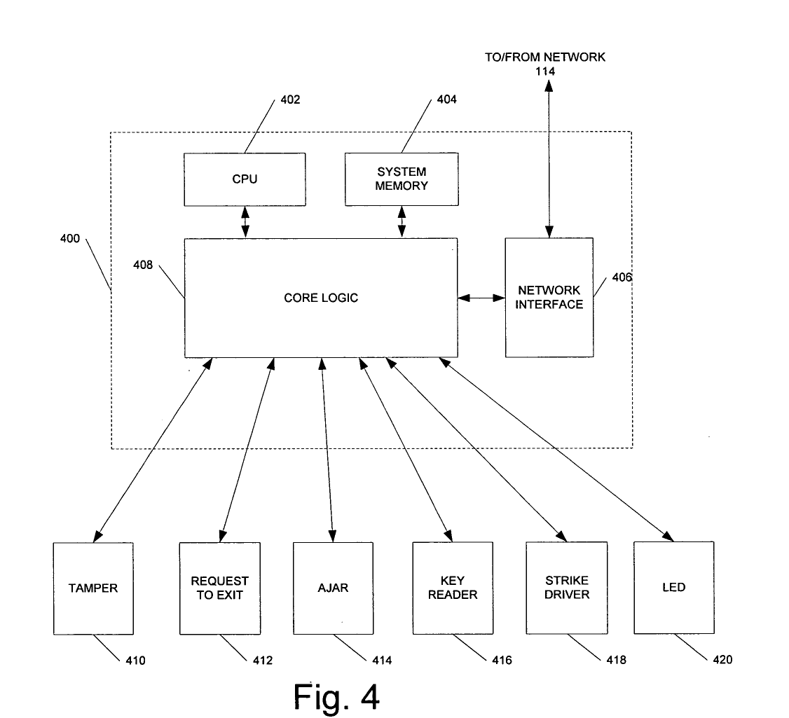

FIG. 4 is a block diagram of an IHS that is representative of the interface module 112, according to the illustrative embodiment. Such representative IHS is indicated by a dashed enclosure 400. The IHS 400 includes a CPU 402, a system memory 404, and a network interface 406. Similar to the IHS 300 of FIG. 3, the IHS 400 includes a core logic 408 which includes electronic circuitry for communicating information and signals (e.g. interfacing or bridging) between the CPU 402 and other electronic circuitry and devices (e.g., the network interface 406). Accordingly, the CPU 402, the system memory 404, the network interface 406 are coupled to the core logic 408.

Also, via the core logic 408, the IHS 400 is coupled to a “tamper” sensor 410, “request to exit (“RTE”)” sensor 412, a door “ajar” sensor 414, a key reader (e.g., a electronic access card reader) 416, a strike driver 418, and an light emitting diode (“LED”) output 420. Each of the tamper sensor 410, the RTE sensor 412, the door ajar sensor 414, and the key reader 416 is an example of the sensors (e.g., the sensor 120) depicted in FIG. 1 and performs sensory (e.g., detection) operations associated with providing security at an entry point (e.g., a door). For example, in response to a person selecting (e.g., pressing) a button to exit through a locked door, the RTE sensor 412 determines that a person has made a request to unlock the door. Also for example, in response to a door being left partially open, the door ajar sensor 414 determines that the door is ajar.

Each of the strike driver 418 and the LED output 420 is an example of the actuators (e.g., the actuator 122) depicted in FIG. 1 and performs actuation operations associated with providing security at a door. In one example, the strike driver is capable of activating an electronic door strike so that a door associated with the door strike is unlocked. In another example, the LED output is capable of causing an LED indicator (e.g., indicator for indicating that a door is unlocked) associated with a door to be activated.

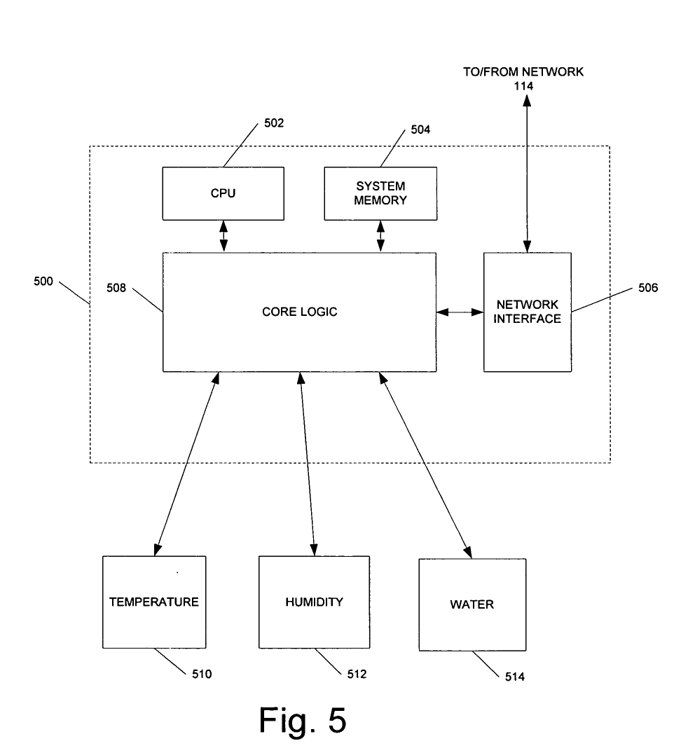

FIG. 5 is a block diagram of another IHS that is representative of the interface module 112 according to the illustrative embodiment. Such representative IHS is indicated by a dashed enclosure 500.

The IHS 500 includes a CPU 502, a system memory 504, a network interface 506, and a core logic 408, each of which is respectively similar to the CPU 402, the system memory 404, the network interface 406, and the core logic 408 of the IHS 400. Similar to the IHS 400, each of the CPU 502, the system memory 504, and the network interface 506 is coupled to the core logic 508.

Also, similar to the IHS 400, the IHS 500 is coupled to various sensors including, a temperature sensor 510, a humidity sensor 512, and a water sensor 514. However, unlike the sensors of the FIG. 4 which are for providing security for an entry point, the sensors of FIG. 5 are for providing security such as security from one or more potentially harmful environmental conditions. For example, the temperature sensor is capable of detecting a temperature value that is higher than a first (e.g., high) threshold temperature value and/or lower than a second (e.g., low) threshold temperature value. In response to detecting such a temperature value (e.g., a potentially harmful range of temperature), one or more of the interface modules and/or the controllers of FIG. 1 are capable of performing a suitable operation (e.g., activate a temperature control device, and/or output an alert message accessible by a pager, a mobile phone, or other suitable devices).

The humidity sensor 512 is capable of detecting a level of humidity that is higher than a first (e.g., high) threshold level or lower than a second (e.g., low) threshold level. In response to detecting such level of humidity (e.g., a potentially harmful level of humidity), one or more of the interface modules and/or the controllers of FIG. 1 are capable of performing a suitable operation (e.g., activate a dehumidifier and/or output an alert message accessible by a pager, a mobile phone, or other suitable devices).

The water sensor 514 is capable of detecting water and/or other liquid. In response to detecting water and/or other liquid, one or more of the interface modules and/or the controllers are capable of performing a suitable operation (e.g., output an alert message accessible by a pager, a mobile phone, or other suitable devices).

As discussed hereinabove, one or more of the controllers 108 and 110, the interface modules 112, 116, and 118, and/or the server 102 are capable of performing various operations for providing physical security in association with the sensors (e.g., the RTE sensor 412) and the actuators (e.g., the strike driver 418). For performing such operations, the server 102 and/or the controllers 108 and 110 are capable of outputting information (e.g., information included by a message) to and/or receiving information from the sensors and the actuators.

In one embodiment, the server 102 outputs and receives such information in response to a request output by the client 104. Also, the client is operable to output such request in response to a user (e.g., the user 202)'s command.

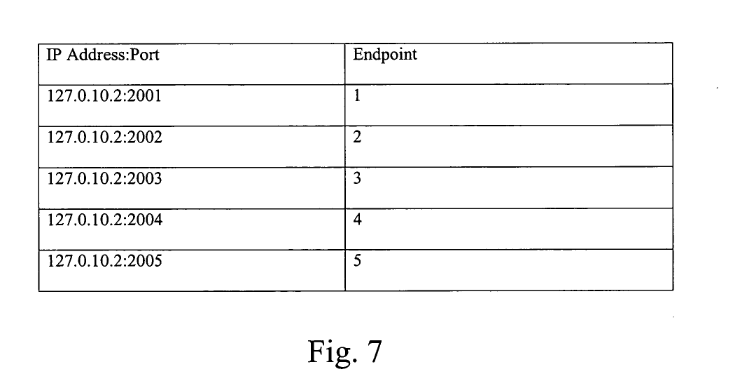

Accordingly, FIG. 6 is a flow chart of operations of a process executed by at least one of the controllers of FIG. 1 in association with communicating information between at least one of the controllers and at least one of the sensors or the actuators. Also, FIG. 7 is an illustration of organization of an address translation database according to the illustrative embodiment. The following discussion simultaneously references FIGS. 6 and 7.

Referring to FIG. 6, the operation begins at a step 602, where the controller self-loops until it determines that it has received a message for output to a sensor or an actuator. In response to the controller determining that it has received a message for output, the operation continues to a step 604.

In one embodiment, the controller receives the message from another TCP/IP device (e.g., the server 102). In one example, the server 102 is operable to output a message addressed to a door ajar sensor (e.g., the door ajar sensor 414) including a request to return a reply message including a door's ajar status. Such message includes the door ajar sensor's destination address in a conventional IP address format including an IP address and a port value. Because the door ajar sensor is not an IP device, the controller receives (e.g., “intercepts”) the message so that it can properly output (e.g., route) the message to the door ajar sensor. In an alternative embodiment, instead of receiving the message from another device, the controller itself forms the message.

Referring again to FIG. 6, at the step 604, in response to the translation database of FIG. 7, the controller determines the destination address (e.g., endpoint identification (“EPID”)) of the sensor or the actuator. Within the network 114, each of the sensors, the actuators, and the devices of the FIG. 1 is addressable by a respective EPID number. Notably, such EPID is a logical address and is variably associated with a physical address (e.g., a physical address of an interface module, a sensor, or an actuator). Also, from a TCP/IP device, each of the sensors, the actuators, and the devices of FIG. 1 is addressable by an associated IP address and a port number. Moreover, as shown in the example FIG. 7, for each IP address and port value combination, the address translation database includes an associated endpoint ID number. For example, if the message received in the step 602 is addressed to a sensor or an actuator having 127.0.10.2 as its IP address and 2001 as its assigned port value, the controller determines that the destination EPID is 1. After the step 604, the operation continues to a step 606.

At the step 606, the controller forms a temporary source address. The temporary source address represents an address, which the sensor or the actuator later uses as a destination address in its reply message. Also, the controller associates the temporary address with the address of the device (e.g., the server 102 or the controller itself) from which the controller received the original message. After the step 606, the operation continues to a step 608.

At the step 608, the controller modifies the message received at the step 602 so that the message now includes the temporary source address formed in the step 606 as the message's source address. After the step 608, the operation continues to a step 610.

At the step 610, the controller outputs, the message modified at the step 608, to the sensor or the actuator associated with the address determined at the step 604. After the step 610, the operation continues to a step 612.

At the step 612, the controller awaits for a reply message from the sensor or the actuator. For example, if the message output at the step 610 includes a request for a status of whether a door is ajar, and the addressee of the message is a door ajar sensor, the controller awaits for a reply message including an indication of whether the door is ajar. Accordingly, the controller determines whether it has received a message addressed to the temporary address formed at the step 606. If so, the operation continues to a step 614.

At the step 614, the controller modifies the message received at the step 612 so that the address now includes the IP address of the controller (which is also the IP address associated with the sensor or the actuator) and the port value for the sensor or the actuator. After the step 614, the operation continues to a step 616.

At the step 616, the controller outputs the message received at the step 612 , to the TCP/IP device (e.g., the server 102) from which the controller received the original message at the step 602. After the step 616, the operation returns to the step 602.

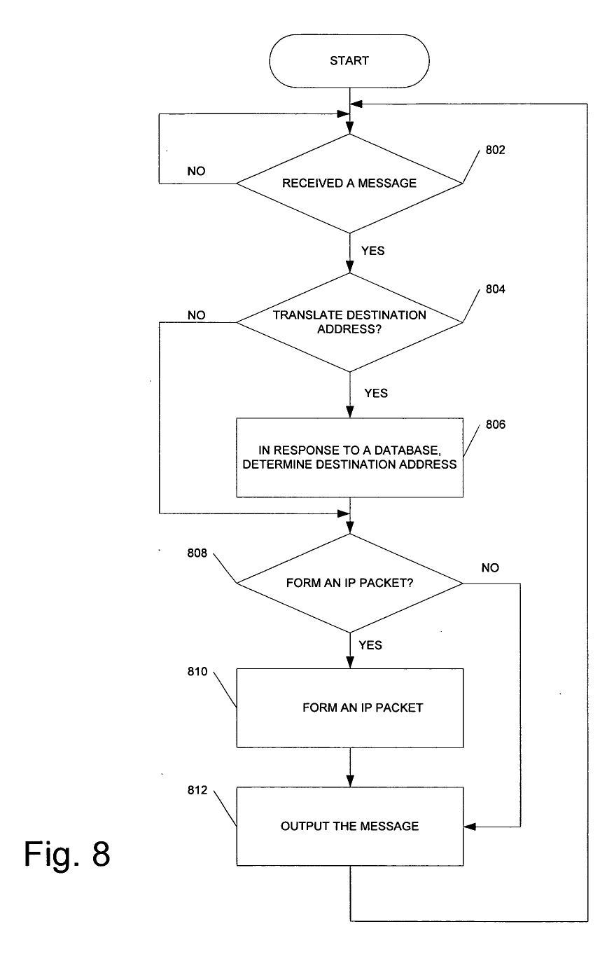

FIG. 8 is a flow chart of operations of a process executed by at least one of the controllers of the FIG. 1 in association with communication of information (e.g., information included by a message) by at least one of the sensors or the actuators to at least one of the controllers or the server.

The following discussion simultaneously references FIGS. 8, 9 and 10. Referring to FIG. 8, the operation begins at a step 802 where the controller self-loops until it has determined that it has received a message from the sensor or the actuator. In the example shown by FIG. 8, the sensor or the actuator outputs the message without being prompted by another device (e.g., the server 102 or the controller). In one example, a key reader (e.g., the key reader 416) outputs the message received by the controller in the step 802. The key reader outputs the message in response to a person presenting a key to the key reader, so that one or more of the controllers and/or the server is capable performing an operation in association with the “key read” event.

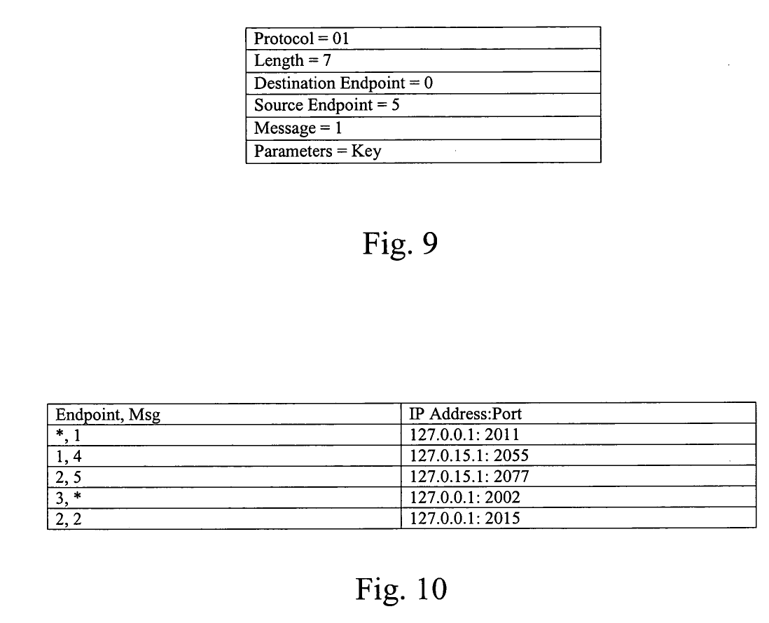

Accordingly, FIG. 9 is an illustration of organization of the message output by the sensor or the actuator to the controllers and/or the server, according to the illustrative embodiment. The message includes various types of information. Such types are illustrative, and not exhaustive. In the example of FIG. 9, the message includes the following parameters: protocol, length, destination endpoint, source point, message, and parameter. Also, such parameters have the following respectively assigned values: 01, 7, 0, 5, 1, and “key”.

Referring again to FIG. 8, at the step 802, if the controller determines that it has received a message, the operation continues to a step 804. At the step 804, the controller determines whether it is specified to determine (e.g., “translate”) the destination address. The controller performs such determination by reading the destination endpoint parameter. If the destination endpoint parameter is assigned a value of 0 (as is the case with the example message depicted in FIG. 8), the controller determines that it is specified to determine the appropriate destination address for the message. If the controller determines that it is not specified to determine the destination address, the operation continues to a step 808. However, if the controller determines otherwise, the operation continues to a step 806.

At the step 806, in response to an address translation database, the controller determines the destination for the message. Accordingly, FIG. 10 is an illustration of organization of the address translation database according to another embodiment. For each endpoint and “msg” combination, the address translation database shown in FIG. 10 stores an associated IP address and a port value. In one example, for a message having an “*” (indicating wild card, or any value) and 1 for endpoint value, and msg value, respectively, the address translation database indicates that an associated IP address is 127.0.0.1 and an associated port value is 2011.

Referring again to FIG. 8, at the step 806, the controller determines the destination address (e.g., IP address and port value) by searching the address translation database for a matching combination of endpoint and msg values. After a successful search, the controller determines that an IP address and a port value associated with the matching combination is the destination address. In one example, for the message depicted in FIG. 9, the msg value is 1 and the endpoint value is 5. Accordingly, for such message, the controller determines that a destination address includes an IP address of 127.0.0.1 and a port value of 2011. After the step 806, the operation continues to a step 808.

At the step 808, the controller determines whether it is specified to form an IP packet (e.g., a user datagram protocol (“UDP”) packet) for the message. The controller determines that it is not specified to form an IP packet for the message if it determines that the message is destined for the controller (e.g., the destination address determined at the step 806 is a local IP address 127.0.0.1). If the controller determines that it is not specified to form an IP packet for the message, the operation continues to a step 812.

The controller determines that it is specified to form an IP packet for the message if it determines that the message is destined for a device other than the controller itself (e.g., the destination address determined at the step 806 is an address other than a local IP address 127.0.0.1). If the controller determines that it is specified to form an IP packet for the message, the operation continues to a step 810.

At the step 810, the controller forms an IP packet for the message. Accordingly, the controller modifies the message so that the message is formatted as an IP packet. After the step 810, the operation continues to a step 812.

At the step 812, the controller outputs the message to a device associated with the address determined at the step 806. For example, if the message is addressed to another device (e.g., the server 102 or another controller), the message outputs the message as an IP packet as formed in the step 810. However, if the message is addressed to the controller itself, the message (e.g., content of the message) is output to another service (e.g., another application) executed by the controller. After the message, the operation returns to the step 802.

The following discussion references the IHS 400 as being the representative IHS for the interface module 112 and the IHS 500 as being the representative IHS for the interface module 116. As discussed above, for performing various security operations, the server and/or the controllers of system 100 are capable of outputting information (e.g., information included by a message) to and/or receiving information from the various sensors and the actuators. Accordingly, the sensors and the actuators are also capable of outputting and receiving such information to/from the server and/or the controllers. Each of the sensors and the actuators performs such outputting and receiving through its respectively associated interface module (e.g., the interface module 112).

For some security operations, a sensor or an actuator does not output a message to a controller and/or a server. For example, if a RTE sensor (e.g., the RTE sensor 412) detects a request to unlock a door (e.g., because a person has pressed a button), in response thereto, the interface module 112 is capable of causing a strike driver (e.g., the strike driver 418) to unlock the door.

However, for other security operations, a sensor or an actuator outputs a message to a controller and/or a server. In one example, if a tamper sensor (e.g., the tamper sensor 410) detects that a door has been tampered with, the sensor outputs a message to a server and/or a controller so that the server and/or the controller performs a suitable operation (e.g., storing a record of the tampering and/or outputting an alert message accessible by a security personnel) in response thereto. In another example, if a water sensor (e.g., the water sensor 514) detects water, the water sensor outputs a message to a controller so that the controller performs one or more suitable operations including outputting an alert message and causing a strike driver to unlock a door so that a person, otherwise without access, is able to enter a premise where the water sensor detected the water.

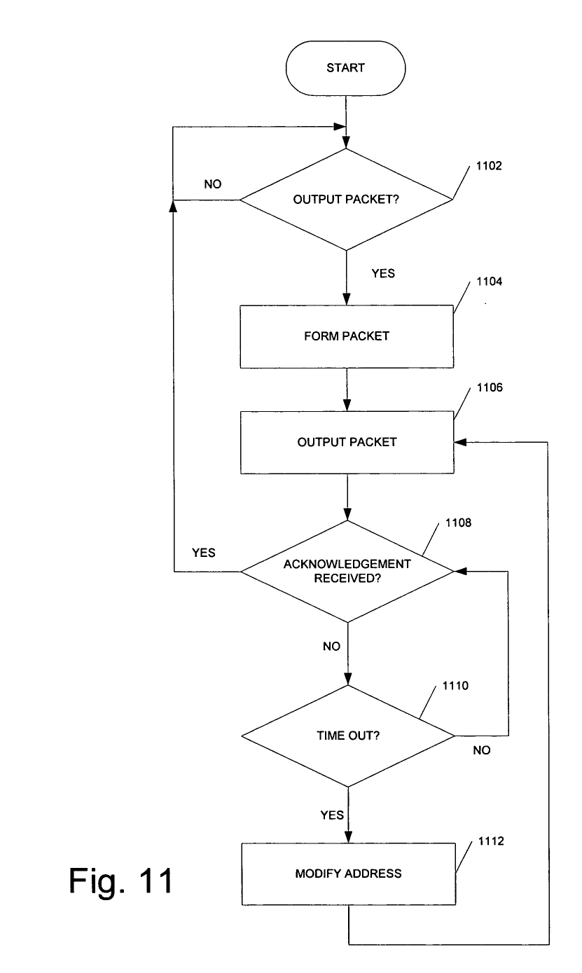

Accordingly, FIG. 11 is a flow chart of operations of a process executed by an interface module. The operation begins at a step 1102 where the interface module self-loops until it determines that it is specified to output a packet to a controller. Notably, even if the packet's ultimate destination is a server, the interface module outputs the packet to the controller so that the controller routes the packet to the server as discussed hereinabove (in connection with FIGS. 6-9). In one example, the interface module determines that it is specified to output a packet in response to one of its associated sensors detecting a “triggering” event (e.g., a door tamper). In response to the interface module making such determination, the operation continues to a step 1104.

At the step 1104, the interface module forms the packet. In at least one embodiment, the packet includes a request for the controller to output an acknowledgement message in response to receiving the packet. After the step 1104, the operation continues to a step 1106

At the step 1106, the interface module outputs the packet to the controller (e.g., the controller 108). After the step 1106, the operation continues to a step 1108.

At the step 1108, the interface module determines whether it has received an acknowledgement message (e.g., a packet). If the interface module determines that it has received an acknowledgement message, this indicates that the controller successfully received the packet output by the interface module at the step 1106. Accordingly, the operation returns to the step 1102. However, if the interface module determines that it has not received an acknowledgment message, the operation continues to a step 1110.

At the step 1101, the interface module determines whether a predetermined period of time for receiving an acknowledgment message has elapsed. In one example, the predetermined period of time is 10 seconds. Accordingly, if 10 seconds have elapsed since the interface module's outputting the message at the step 1106, the interface module determines that the predetermined period of time has elapsed (e.g., “time is up”). If the interface module determines that the predetermined period of time has not elapsed, the operation returns to the step 1108, where the interface module again determines whether it has received an acknowledgement message. If the interface module determines otherwise, the interface module also determines that the controller failed to receive the packet output at the step 1106. Accordingly, the operation continues to a step 1112.

At the step 1112, the interface module modifies the packet that was formed at the step 1104, so that the packet is now addressed to all devices on a network (e.g., the network 114), forming a broadcast packet, or the packet is addressed to another controller (e.g., the controller 110) in a point to point manner. After the step 1112, the operation returns to the step 1106, where the interface controller outputs the modified packet.

Referring again to FIG. 3, the IHS 300 includes the flash memory 306 for installation on the IHS 300 to configure one or more of its operations (e.g., by storing the IHS 300's various configuration information). The flash memory 306 is replaceable so that if a user couples (e.g., installs) a replacement flash memory (e.g., a flash memory that is substantially similar to the flash memory 306) to the IHS 300, the IHS 300 is capable operating in association with configuration information stored by the replacement flash memory. Similarly, the flash memory 300 is removable so that if a user removes the flash memory 300 and installs it on a replacement IHS (e.g., an IHS that is substantially similar to the IHS 300), the replacement IHS is capable of operating in association with the configuration stored by the flash memory 300.

In at least one alternative embodiment, the flash memory 306 stores network identification information so that when installed on a replacement IHS, the replacement fHS is capable of authenticating to a network (e.g., the network 106) with the identification information stored by the flash memory 306. After authenticating to the network, the replacement IHS is capable of receiving configuration information so that the IHS 300 operates in association with the received configuration information.

In one embodiment, the flash memory 300 is included by a computer chip enclosed in a ruggedized container (e.g., a “button”) that is approximately 16 mm. In one version of such embodiment, the container is a steel container. Accordingly, the steel container is portable and installable in various systems and environments. The steel container is capable of operating as an interface for an electronic transmission (e.g., a transmission between the flash memory 300 and the IHS 300). In one example, a “lid” of the steel container includes an information contact, and a “base” of the contact includes a ground contact. Also, the lid and the base are interposed by a nonconductive (e.g., polypropylene) grommet.

The steel container communicates by the 1-Wire protocol, which includes a communication speed selectable between 16 kbs and 142 kbs. Each steel container also includes a unique and unchangeable identifier (e.g., address). In one example, such identifier is written into the steel container's electronic circuitry and laser etched on a portion of the steel container.

Referring again to FIG. 1, as described hereinabove, the controllers 108 and 110 and the server 102 are capable of receiving information about a state (e.g., status) of each of the sensors and the actuators. In one example, each of the sensors (e.g., the RTE sensor 412) and the actuators (e.g., strike driver 418), includes a switch that indicates the sensor's or the actuator's state. For example, if the RTE sensor 412's switch is in a “closed”state, the switch indicates that a person has made a request to exit (e.g., the person has pressed a button for making such request). However, for another RTE sensor (e.g., an RTE sensor from another manufacturer), a closed switch indicates that a request to exit is not detected.

Accordingly, for each class (e.g., type) of sensor and actuator, the interface modules of the system 100 translate (e.g., “normalize”) states exhibited by the sensor or the actuator so that each of the states output by the sensor or the actuator appears substantially uniform to a receiving controller. In one example, for a given type of sensor, the possible logic states are “activated” and “inactivated”. Accordingly, regardless of whether a RTE sensor's switch is open, if the RTE sensor detects that a person has pressed a button to make a request to exit, the RTE sensor's state indicates that the RTE sensor is activated.

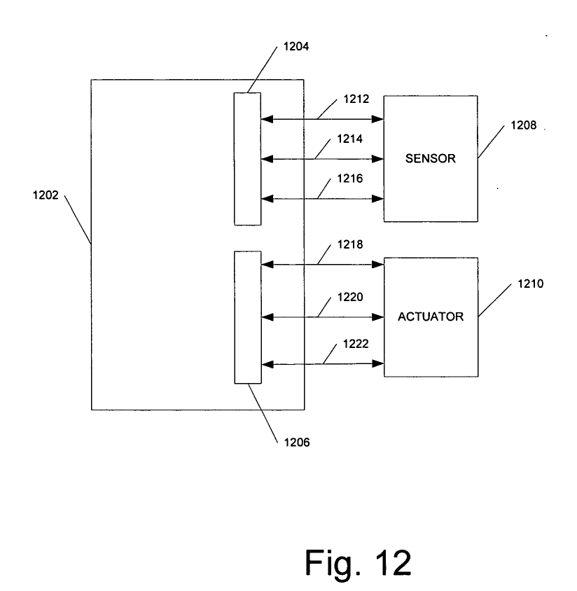

FIG. 12 is a block diagram of an interconnection between one of the interface modules of FIG. 1, and a sensor and an actuator. An interface module 1202 is coupled to a sensor 1208 via a sensor interface 1204. More particularly, the sensor interface 1204 is coupled to the sensor 1208 via wires 1212, 1214, and 1216.

The interface module 1202 is also coupled to an actuator 1210 via an actuator interface 1206. More particularly, the actuator interface 1206 is coupled to the actuator 1210 via wires 1218, 1220, and 1222.

In one example, the interface module 1202's core logic (e.g., the core logic 112 of the IHS 300) includes the interfaces 1204 and 1206. The interfaces 1204 and 1206 are physically and/or electronically adapted so that the interface module 1202 is capable of being coupled to sensors and actuators that are compatible because, for example, they are associated with a specified entity (e.g., manufacturer and seller of sensors and actuators). Also, each of the wires 1212, 1214, 1216, 1218. 1220, and 1222 includes a color that is a part of a wiring color scheme that is specific for an entity. Moreover, the interface module 1202 includes a wiring color scheme that is substantially identical to a wiring color scheme of the sensor 1208 and the actuator 1210.

Accordingly, each of the interface modules 112, 116, and 118 is capable of having an interface for coupling one or more sensors and actuators that are associated with a specified entity. Also, each of the interface modules 112, 116, and 118 is capable of including one or more wires having one or more colors that are substantially identical to one or more colors of wires of sensors and actuators associated with a specified entity. An interface module and a sensor and/or actuator having substantially identical color schemes indicates that the interface module and the sensor and/or the actuator are compatible with one another.

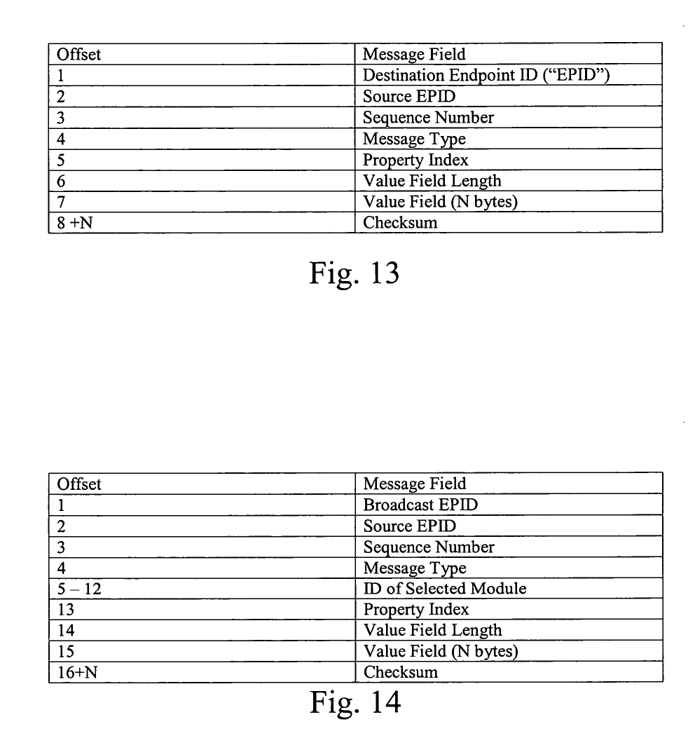

FIG. 13 is an illustration of organization of a packet output and received by the devices of FIG. 1 (e.g., the sensor 120) that are coupled to the network 114, according to a first embodiment. The packet includes various types of information. Such types are illustrative, and not exhaustive.

Each of the message fields of the packet is associated with an “offset” (e.g., a byte offset). For example, at each of offsets 1, 2, 3, 4, 5, 6, 7, and 8+N, the packet respectively includes a destination endpoint identification (e.g., “EPID”), a source EPID, a sequence number, a message type (e.g., a “get” message or a “set” message), a property index, a value field length, a value field, and a checksum. The packet of FIG. 13 is a point to point packet. Accordingly, the destination EPID field includes an EPID of a specified device.

FIG. 14 is an illustration of organization of a packet output and received by the devices of FIG. 1 (e.g., the sensor 120) that are coupled to the network 114, according to a second embodiment. The packet includes various types of information. Such types are illustrative, and not exhaustive.

Similar to the packet of FIG. 13, each of the message fields of the packet of FIG. 14 is associated with an “offset” (e.g., a byte offset). For example, at each of offsets 1, 2, 3, 4, 5-12, 13, 14, 15, and 16+N, the packet respectively includes a broadcast EPID, a source EPID, a sequence number, a message type (e.g., a “get” message or a “set” message), identification information of a selected interface module, a property index, a value field length, a value field, and a checksum. In contrast to the packet of FIG. 13, the packet of FIG. 14 is a broadcast packet. Accordingly, the packet includes a broadcast EPID associated with the offset 1.

Although illustrative embodiments have been shown and described, a wide range of modification, change and substitution is contemplated in the foregoing disclosure and, in some instances, some features of the embodiments may be employed without a corresponding use of other features.

1. A method performed by an information handling system (“IHS”), the method comprising:
outputting, via an Internet protocol, a message, in response to which, one or more devices perform one or more operations for providing physical security.

2. The method of claim 1, wherein the Internet protocol is Transport Control Protocol/Internet Protocol (“TCP/IP”).

3. The method of claim 1, wherein the outputting includes:
outputting the message across two or more networks.

4. The method of claim 3, wherein the networks include a first network and a second network that is a different type of a network from the first network.

5. The method of claim 4, wherein the devices are coupled to the second network.

6. The method of claim 5, wherein the second network is a serial network.

7. The method of claim 6, wherein the second network is a RS485 network.

8. The method of claim 5, wherein the second network is a wireless network.

9. The method of claim 8, wherein the second network is a wireless mesh network.

10. The method of claim 4, and comprising:
in response to a network address associated with the first network, determining the device's network address on the second network.

11. The method of claim 10, wherein the determining includes:
determining in response to a database.

12. The method of claim 1, wherein the device includes a sensor.

13. The method of claim 1, wherein the device includes an actuator.

14. The method of claim 1, wherein the device is included by one of various classes of devices, and the outputting is normalized for each of the classes.

15. The method of claim 1, wherein the message is a first message and comprising:
receiving a second message from the device.

16. The method of claim 15, wherein the device is included by one of various classes of devices, and the receiving is normalized for each of the classes.

17. A system, comprising:
an information handling system (“IHS”) for: outputting, via an Internet protocol, a message, in response to which, one or more devices perform one or more operations for providing physical security.

18. The system of claim 17, wherein the Internet protocol is Transport Control Protocol/Internet Protocol (“TCP/IP”).

19. The system of claim 17, wherein the outputting includes:
outputting the message across two or more networks.

20. The system of claim 19, wherein the networks include a first network and a second network that is a different type of a network from the first network.

21. The system of claim 20, wherein the devices are coupled to the second network.

22. The system of claim 21, wherein the second network is a serial network.

23. The system of claim 22, wherein the second network is a RS485 network.

24. The system of claim 21, wherein the second network is a wireless network.

25. The system of claim 24, wherein the second network is a wireless mesh network.

26. The system of claim 20, wherein the IHS is for: in response to a network address associated with the first network, determining the device's network address on the second network.

27. The system of claim 26, wherein the determining includes:
determining in response to a database.

28. The system of claim 17, wherein the device includes a sensor.

29. The system of claim 17, wherein the device includes an actuator.

30. The system of claim 17, wherein the device is included by one of various classes of devices, and the outputting is normalized for each of the classes.

31. The system of claim 17, wherein the message is a first message and comprising:
receiving a second message from the device.

32. The system of claim 31, wherein the device is included by one of various classes of devices, and the receiving is normalized for each of the classes.
